(19) United States
(12) Patent Application Publication
(10) Pub. No.: US 2003/0042474 A1
(43) Pub. Date: Mar. 6, 2003

(54) Roofer's hammer

(76) Inventor: Kevin Boydon, New Baltimore, MI (US)

Correspondence Address: John R. Benefiel, Suite 100 B, 280 Daines Street, Birmingham, MI, 48009, US

(21) Appl. No.: 09/881,364

(22) Filed: Jun. 14, 2001

(51) Int. Cl. B25C 11/00

(52) U.S. Cl. 254/25

(57) ABSTRACT

A roofer's hammer having multiple pry features of varying configurations as well as a striking face on a head portion. One feature is formed on the handle end, another comprises a special claw on the head portion, and a pry tooth projects to one side of the claw.

### BACKGROUND OF THE INVENTION

This invention concerns hammers and more particularly hammers suited for use by a roofer in carrying out prying and/or nail removal tasks of the type encountered when roofing.

A standard carpenter's hammer has a curving claw projecting back from the striking face. Such a standard claw is often awkward to use for prying, as the handle must be tilted forward, and forward clearance is sometimes not available. The hammer head configuration does not create a great deal of leverage, such that excessive effort is required, even for extracting nails.

Further, the standard hammer claw is not well suited to a variety of prying applications encountered by a roofer, as when inserting the same under shingles, trim, flashing, siding, etc., and a roofer usually must carry other pry tools in addition to a hammer.

Another roofer need is convenience in carrying the hammer, as the roofer is usually working on his knees or stooped over, such that a belt holder make removing the hammer awkward or necessitates standing up. Since a roofer must use his hammer frequently, even a slight hindrance is burdensome over the course of a work day.

It has heretofore been proposed to provide a leg holster for hammers as shown in U.S. Pat. No. 5,605,263, but that holster is complex and costly as it has a number of mechanical parts, and some effort is required in seating the hammer in the holder.

It is an object of the present invention to provide a hammer having multiple pry and extraction features which are configured to be particularly effective for roofers.

It is another object to provide a simple and convenient leg mounted holder for a roofer's hammer.

### SUMMARY OF THE INVENTION

The above recited objects and others which will be understood upon a reading of the following specification and claims are achieved by a tool comprising a hammer having multiple pry features. The hammer is preferably of one piece metal construction including a striking head having a rigid handle attached at one end to the head and formed at its free end with slightly angled chisel prongs separated with a V-shaped slot. A bulging shape of the handle end together with a slight angling of the prongs allows a powerful mechanical advantage to be developed when grasping the head and using the handle length for leverage. The slight angle of the prongs allow the handle to extend away from a nail or shingle at a shallow angle to allow easy, convenient prying and extraction.

An extraction claw is also provided on one end of a head portion, which is of longer length than standard hammers, and which is flattened and extends from an angled surface of the striking head end to allow great leverage when prying or extracting a nail.

A pry tooth is optionally provided projecting from the outer side of at least one prong of the claw, which is effectively engageable with a siding piece to slightly pry the same away from a vertical wall adjacent a roof surface by a force exerted with the tool handle.

This feature is useful to loosen siding and allow roof flashing to be inserted under the siding.

Thus, a hammer with multiple pry features having varying configurations to allow effective prying for many different situations is provided, while still allowing effective use as a striking tool.

A holder is also provided for the tool, adapted to be strapped to the lower leg of a user, which has a receptacle at the lower end of an elongated support having leg straps attached thereto. The tool head is inserted into the receptacle, with a spring retainer holding the same therein, the tool handle extending up the elongated member.

### DESCRIPTION OF THE DRAWINGS

FIG. 1 is a perspective view of the roofer's hammer according to the invention, inserted in a holder according to the invention.

FIG. 2 is a fragmentary enlarged end view of the head of the hammer shown in FIG. 1, with a sectional view of the holder receptacle receiving the hammer head.

FIG. 3 is a side view of the roofer's hammer shown in FIGS. 1 and 2.

FIG. 4 is an end view of the head of the roofer's hammer shown in FIGS. 1-3, with a fragmentary portion of the handle.

FIG. 5 is an opposite end view of the head of the roofer's hammer shown in FIG. 4.

FIG. 6 is an enlarged side view of the end of the hammer handle, shown engaging a nail being extracted.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

Referring to the drawings and particularly FIG. 1, the roofer's hammer 10 is shown held in a strap-on holder 12 which includes a receptacle 14 configured to receive the angled side head 16 of the hammer 10. An elongated support piece 18 is fixed to the receptacle 14 extending upwardly alongside a handle 20 of the hammer 10.

A pair of straps 22 are attached at spaced apart locations along the piece 18 with hook and loop patches 24, 26 allowing the straps to be secured encircling the leg of a wearer.

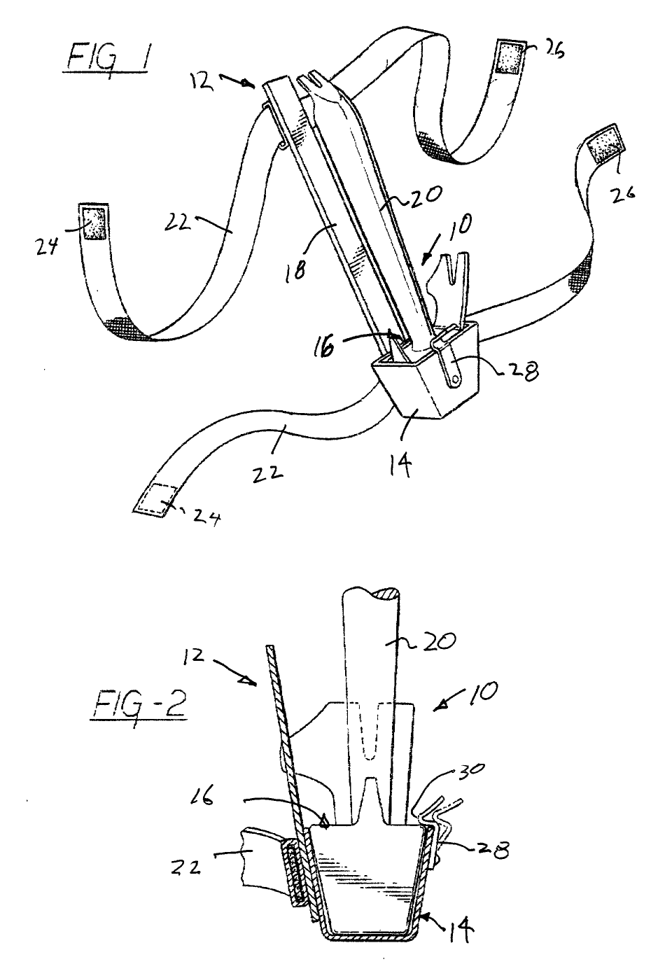

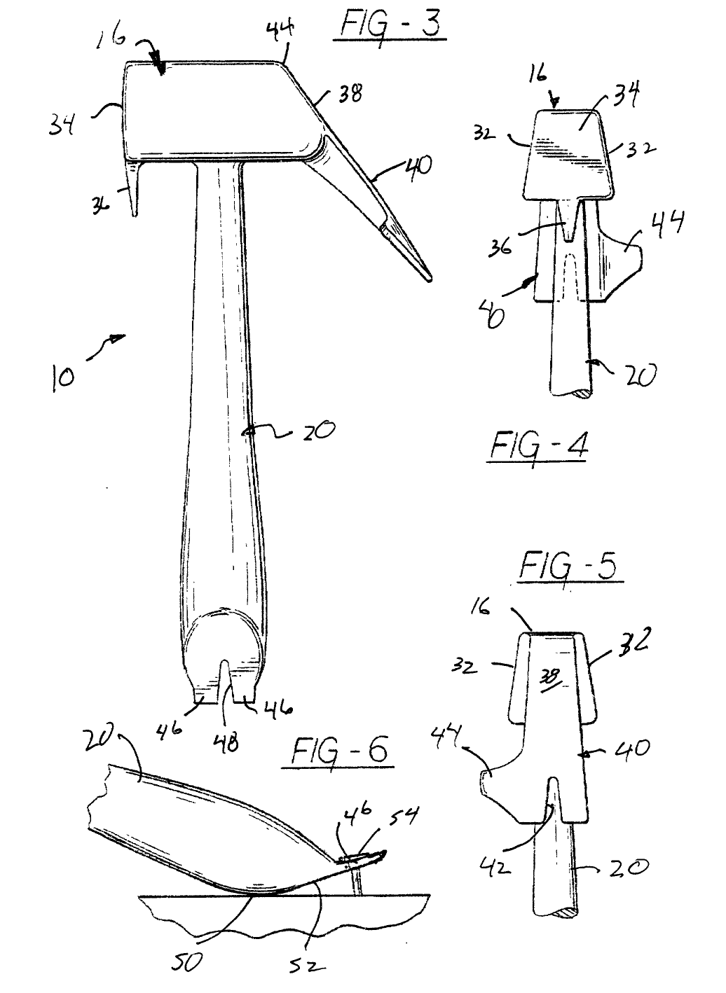

A spring strip catch 28 has a lip 30 urged to project over the top edge of the receptacle 14 (FIG. 2), which prevents the head 16 from slipping out, but which is easily deflected when the user pulls the hammer 10 out of the receptacle 14.

The hammer 10 is preferably of one piece construction of forged steel, with the handle 20 formed integrally with the head 16.

The head 16 has a flat striking face 34 at one end, a downwardly extending projection 36 provided to allow retention in a conventional belt loop holder (not shown).

The head has sloping sides 32 (FIG. 4) to be snugly received into the correspondingly sloping sided receptacle 14.

The head 16 has an opposite face 38 its angled down and blending into an elongated tapered thickness claw 40 extending outwardly and downwardly from the opposite face 38.

A V-shaped slot 42 (FIG. 5) is formed into the end of the claw 40. The corner 44 of the angled face 38 forms a fulcrum point when using the claw 40 for nail extraction or prying. The long length of the claw 40 makes it effective for loosening shingles without breakage. The claw 40 can be urged to punch a hole in plywood, siding, etc., and is designed to be sufficiently sturdy for that purpose.

An auxiliary pry tooth feature 44 projects laterally from one side of the claw 40 adjacent the end thereof.

This pry tooth feature 44 is effective at loosening siding on a vertical wall intersecting the roof. The hammer 10 is angled slightly away from the wall with the handle extending alongside the wall, the feature 44 can be engaged with the bottom edge of the siding. When the handle 20 is pulled back, the head engaging the roof surface, the pry tooth feature 44 exerts a pulling force on the siding, enabling it to be loosened. This allows flashing pieces to be inserted under the siding.

The handle 20 is formed with pry-extraction prongs 46 separated by a V-shaped slot 48. The prongs 46 integral with the handle end and are angled out slightly from the handle axis (FIG. 6). The handle 20 has a bulge 50 at the end adjacent an inclined face 52 blending into the prongs 46. The bulge 50 creates a fulcrum when prying using the prongs 46, or when extracting a nail 54. Since the entire length of the handle 20 is available as a lever arm acting on the short distance from the bulge 50 to the slot 48, considerable force can be exerted. This pry feature can more easily be used in many situations than a standard hammer claw, and allows the use of the knee to apply a force to the handle.

Thus, a hammer having multiple pry features of very different configurations is provided, to be quite versatile in use to be particularly useful to a roofer.

1. A tool, comprising:
an elongated handle;
a head portion at one end of said handle having a striking face;
said handle having a chisel pry edge formed on an end portion opposite said head portion, said end portion inclined slightly out from a longitudinal axis of said handle;
an inclined end face on said handle end portion blending into said pry feature; said handle end portion having an enlarged portion closely spaced from said pry feature to form a fulcrum;
a claw formed on said head portion on an end thereof opposite said striking face extending downwardly and outwardly from said head portion, a V-shaped slot formed in from an outer edge thereof.

2. A tool according to claim 1 wherein said head portion end thereof has a sloping end face blending into said claw, formed a corner defining a fulcrum.

3. A tool according to claim 1 wherein said chisel pry edge has a V-shaped slot extending thereinto.

4. A tool according to claim 2 further including a pry tooth projecting laterally from one side of said claw adjacent said outer edge thereof.

5. A tool according to claim 4 further including a downwardly projection formed on said head portion adjacent said striking face.

6. A tool according to claim 5 wherein said tool is constructed entirely of steel with said head, handle, and claw of integral construction.

7. A tool holder for a hammer having an elongated handle with a head portion at one end, comprising:
an open topped receptacle configured to receive said hammer head portion;
an elongate support having one end attached to one side said receptacle;
a retainer engaging said head portion to be reliantly deflected as said head portion moves past and thereafter restored to prevent said head portion from sliding out of said receptacle;
while allowing said head portion to be pulled out by again deflecting said retainer;
a support member extending from said receptacle having a pair of straps attached thereto for encircling a wearer's leg, with a securement for each strap to be held encircling said wearer's leg.

8. The tool holder according to claim 7 wherein said hammer head portion has sloping sides and said receptacle has sloping side to be interfit thereto with said head portion disposed therein.

9. The tool holder according to claim 7 wherein said retainer comprises a spring blade formed with a lip projecting over said receptacle.

10. The tool holder according to claim 7 wherein said support member is elongated and extends alongside said hammer handle with said head portion disposed in said receptacle.
